(19) United States
(12) Patent Application Publication
(10) Pub. No.: US 2008/0301102 A1
(43) Pub. Date: Dec. 4, 2008

(54) STORE PRODUCT LOCATING SYSTEM

(76) Inventor: Susan LIANG, Honolulu, HI (US)

Correspondence Address: LEIGHTON K. CHONG;PATENT ATTORNEY, 133 KAAI STREET, HONOLULU, HI, 96821, US

(21) Appl. No.: 12/107,582

(22) Filed: Apr. 22, 2008

Related U.S. Application Data
(60) Provisional application No. 60/930,902, filed on May 18, 2007.

(51) Int. Cl. G06F 17/30

(52) U.S. Cl. 707/3; 705/27

(57) ABSTRACT

A store product locating system and method enables a customer to locate a product quickly at its exact position within the store. Using a kiosk, a customer can input a name for a product they are searching for, the system searches for the product in its database of products and their locations, and the system then displays the location of the product on a floor plan map. The customer can input a number of products being searched for, and the system displays the location of each product in turn along with already-input product locations. The system prints out a map with the locations of the products requested marked on the map. The system can also enable input by customer voice request, uploading a list of products shopped for from a flash memory device or handheld device, and downloading to the handheld device, as well as uploading a list of items to a store's website from a PC.

This U.S. patent application claims the priority filing date of U.S. Provisional Application 60/930,902 filed on May 18, 2007, by the same inventor in the present application.

### TECHNICAL FIELD

This invention generally relates to store maps, and specifically to store floor plan maps that enable customers to locate the shelf or display positions of products in the store.

### BACKGROUND OF INVENTION

Conventional store mapping or product locating systems typically show a floor plan for a floor of a store in which various store departments or aisles are depicted, and various product types or groupings are labeled as sections on the floor plan. Other product locating systems include those that provide a display board index to the aisle numbers of various product types or groupings. With these conventional store mapping and product locating systems, customers often have difficulty locating a product if they search for it by a name or phrase not used in the store floor plan maps or product indexes. Also, within any given product department or aisle, there may be many brands, styles and sizes of products of similar type being stocked within a large area or shelf space, and it may be difficult for a customer to pinpoint the exact location of the product they are searching for, thereby requiring them to hunt up and down the aisle.

### SUMMARY OF INVENTION

In the present invention, a store product locating system enables a customer to locate a product quickly at its exact position within the store. Using any one of a number of kiosks or terminals positioned near customer access points within a store, a customer can input a name or phrase for a product they are searching for, and the system will search its database for the product name using interpretive logic to find the exact or closest match to the customer's input query. The exact stocking location of the product is then displayed visually on a floor plan map, showing not only its department name or aisle number but also its exact location within that department or aisle. The customer can input a number of products being searched for, and the system adds to the map display the location of each input product in turn (with a blinking point), along with the already-input product locations maintained on the display screen (steady points). When the customer has finished inputting the products they are searching for, the system prints out a floor plan map with the locations for all of the products requested marked on the map. In this manner, the customer can shop from department to department, or aisle to aisle, going to the exact locations of the products they requested, without having to backtrack or criss-cross around the store, thereby saving time and greatly adding to customer convenience.

Optional or extension features of the system include: (a) allowing customer input by voice request and providing voice responses; (b) enabling the customer to electronically input a list of items shopped for from a flash memory device or from a cell phone, PDA, or other handheld device; (c) outputting the floor plan map and product locations to a cell phone, PDA, or other handheld device as a text or multimedia message display; (d) enabling a customer to upload a list of items shopped for to a store's website from a PC, and downloading the resultant floor plan map with products marked thereon to the customer's PC for printing or to a pickup bin under the customer's name in the store; and (e) enabling the system's database to handle requests in other languages.

### BRIEF DESCRIPTION OF DRAWINGS

FIG. 1A illustrates a simplified input interface for an in-store product location search engine in the present invention, and FIG. 1B illustrates an in-store product location terminal or kiosk.

FIG. 2 illustrates a visual display of floor plans for a store used in the product location mapping system.

FIG. 3 illustrates a visual display of the exact location of a product by the product location mapping system of the present invention.

FIG. 4 shows an example of a preferred database structure for the store product-locating system.

FIG. 5 is a flow diagram for the logic sequence of the store product-locating system.

### DETAILED DESCRIPTION OF INVENTION

In the following detailed description, certain preferred embodiments are described as illustrations of the invention in a specific application, network, or computer environment in order to provide a thorough understanding of the present invention. Those methods, procedures, components, or functions which are commonly known to persons of ordinary skill in the field of the invention are not described in detail as not to unnecessarily obscure a concise description of the present invention. Certain specific embodiments or examples are given for purposes of illustration only, and it will be recognized by one skilled in the art that the present invention may be practiced in other analogous applications or environments and/or with other analogous or equivalent variations of the illustrative embodiments.

Some portions of the detailed description which follows are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “translating” or “calculating” or “determining” or “displaying” or “recognizing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Aspects of the present invention, described below, are discussed in terms of steps executed on a computer system, which may be one of any type having suitable computing resources. Aspects of the present invention are also discussed with respect to an Internet system including electronic devices and servers coupled together within the Internet platform, but it may be similarly implemented on any other type of extended network system including wireless data or digital phone networks. A computer system can also include a communication device for interfacing with other networks or sending messages over the Internet or wireless communications systems. The system may be implemented using PC or client computers coupled to a wired network, or using mobile devices connected to a mobile or wireless network.

It is also noted that the present preferred embodiment contains references to technologies presently available in the marketplace. The invention in its essence, however, is not in anyway tied to any particular technology, but rather only requires that any present or future method deliver key data elements in a way that is consistent herewith.

In the following description, the following acronyms are used as abbreviated terminology for convenience, or to acronyms for computerized tools or constructs that are well understood to those skilled in the field of art to which the present invention pertains. “SPS” refers interchangeably to “Store Positioning System” or “Store Product-Locating System”. “API” refers to “Application Programming Interface”. “DLL” refers to “Dynamic Link Library”. “ID” refers to “Identification”. “PDA” refers to a “Personal Digital Assistant”. “RDMS” refers to a “Relational Database Management System”. “TSN” refers to a “Transaction Sequence Number”.

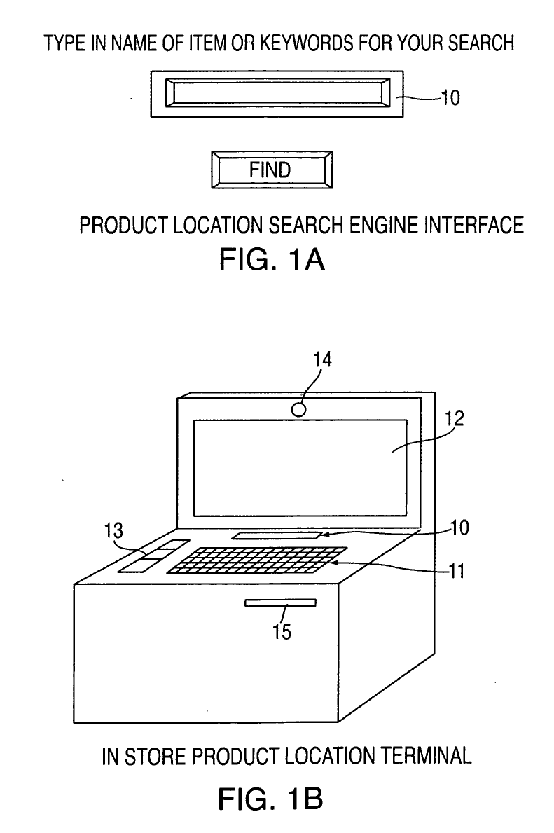

Referring to FIGS. 1A and 1B, an in-store product-locating system in accordance with the present invention enables a customer to input a name or phrase for a product being searched for, in order to find its exact location of a store floor plan map. Using any one of a number of kiosks or terminals positioned near customer access points within a store, a customer can input a name or phrase using a keyboard 11 and verify the name and spelling on an input display line 10. The SPS system will search its database for the product name using interpretative logic to find the exact or closest match to the customer's input query. The exact stocking location of the product is then displayed visually on a floor plan map on a kiosk display 12, showing not only its department name or aisle number but also its exact location within that department or aisle.

The customer may make other functional selections for the operation of the SPS system using navigation buttons 13, such as selection of a language (“English”, “Spanish”, “Chinese”, “Japanese”, “Korean”) that the customer desires for display of the input line 11 and floor plan map 12. The customer can input a number of products being searched for, and the system adds to the map display the location of each input product in turn (with a blinking point), along with the already-input product locations maintained on the display screen (steady points). The customer can optionally upload a list of the items searched for from a handheld device to an electronic receiver 14 (e.g., for Bluetooth transmission). The electronic receiver 14 may also include an electronic transmitter for transmitting a map of product locations to the customer's handheld device. When the customer has finished inputting the products they are searching for, the SPS system prints out a floor plan map with the locations for all of the products requested marked on the map, as indicated by the print delivery slot 15.

The SPS system is composed of three (3) basic software components: (a) Front End User Search Interface; (b) Back End Database; and (c) Display Interfaces. The Front End User Search Interface allows a user to input a search term then formats search query requests to the Back End Database using interpretive logic. In a basic form, the interpretative logic can use a dictionary of commonly used product names to find an exact or closest match to the product name listed in the store's product inventory listing. In a more advanced form, the interpretive logic can use semantic parsing of the input term to find a closest match. These types of interpretive methods are well known to those skilled in the art and are not described in further detail herein. The Front End User Interface can be built on a suitable programming development platform, such as Visual Basic Net, Delphi, C++, Java, or Ruby.

The Back End Database typically consists of the location and description of the product items available in the store. Retail stores commonly maintain database listings of all products stocked in the store identified by Universal Product Code (UPC) or SKU numbers, and use these codes to identify the products' area or shelf location. The Back End Database data can be entered manually or imported from an existing store inventory database. The Display Interfaces can be implemented using standard application programming platforms. The Display Interfaces can also be adapted to receive and send data to/from a printer or handheld device such as a cell phone or PDA. An output of the identified product location(s), once located and displayed on the screen 12, can be transferred to the printer and delivered via slot 15, or transmitted to a wireless device, such as a PDA or a cell phone.

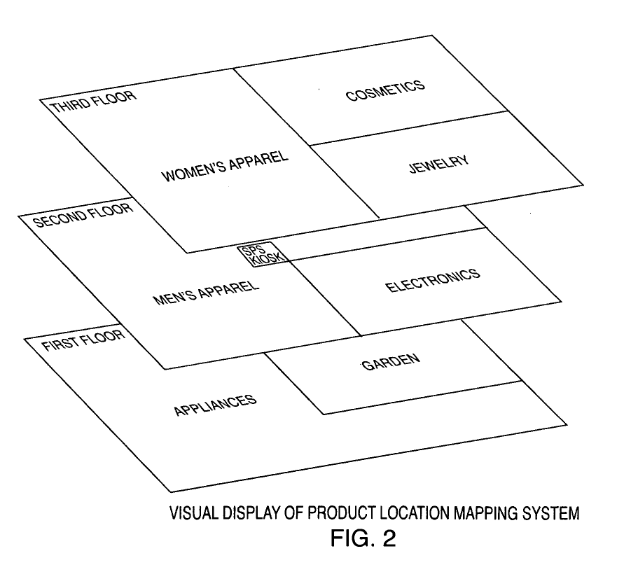

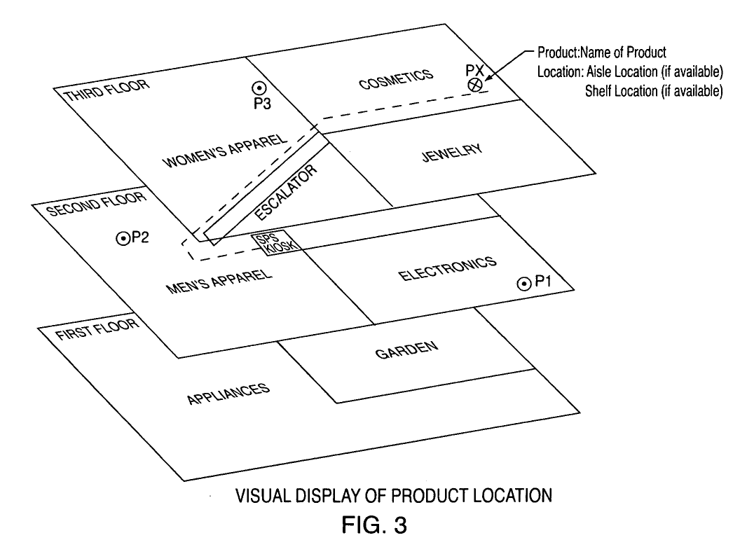

A preferred implementation of the SPS system employs a store mapping system based on floor plans and visual displays of product locations within the store. FIG. 2 illustrates a visual display of floor plans for a store used in the SPS system. When the customer inputs a product location request on the SPS kiosk such as by typing in keywords for the product, the SPS responds by displaying the location on the floor plan where the product is located, including its aisle and shelf locations (numbers or letters) if available. FIG. 3 illustrates a visual display of the exact location of a product by the SPS system. It may also display a picture of the item or related items in the same categories. If a list of items is entered, these will be displayed on the map as well (P1, P2, P3, PX . . . ). The customer can then select the item they are searching for printing or other output. In addition, the SPS can show the location of the customer (“you are here”) and a dashed arrow indicating the direction and path of travel to reach the location of the product in the store. The customer can continue and request other items in a new search, or if finished, can get a printout of the map showing the path of travel to the product(s). The customer may also have the option to transfer (export) the map to their PDA or cell phone.

The preferred implementation of the Front End User Interface of the SPS system encompasses a single entry multi-keyword entry search using a drill down method (FIG. 1A). The different levels include departments, major categories, brands, models, name, etc. The initial search will return departments and/or major categories relating to keyword search. If the search is an exact match to the product name, the product will be displayed. The user has the choice to select the matching product or the matching category or department which will lead the user to a more refined search. The SPS database search will continue until the product has been located. If the search leads to a wrong direction, the user has the choice of going back one step or to start a new search. Once the product has been correctly identified, the SPS will display a visual map of the store and directional arrow showing where the product is located and how to get to the product from the current location (FIG. 3).

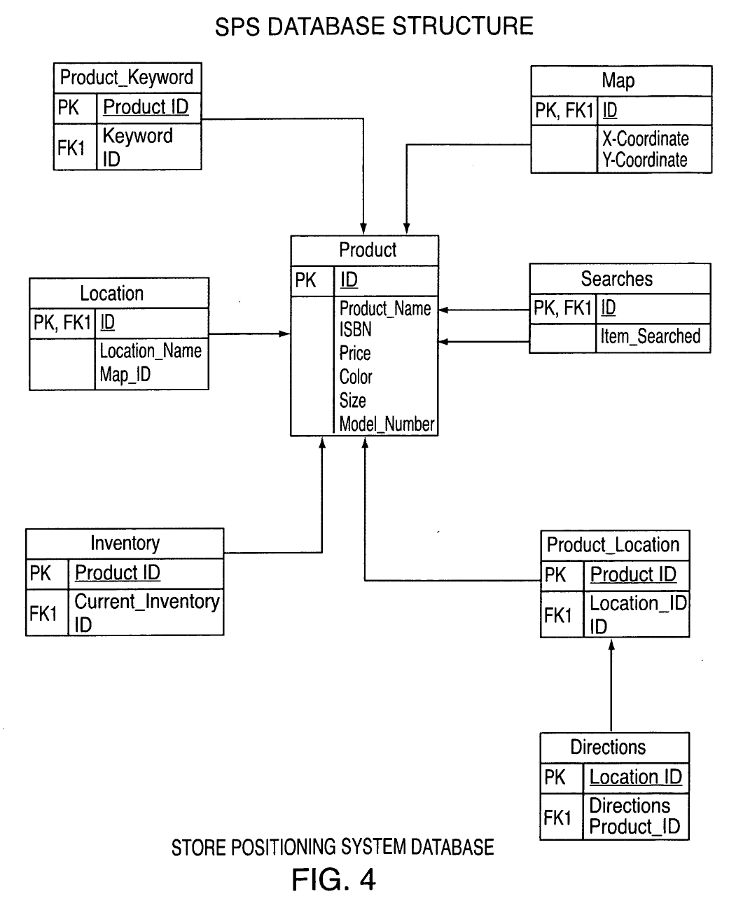

The preferred implementation of the Back End Database of the SPS system can utilize any type of standard database (Oracle, Microsoft SQL, Postgre SQL, etc.). The Database contains the critical data that is required for the search and display of the product and its location, such as product name, UPC, SKU, or ISBN numbers, map location, search criteria, and inventory status if available. FIG. 4 shows an example of a preferred database structure for the store product-locating system. The SPS database has a built-in import function to import comma delimited files from existing inventory databases of stores implementing the SPS. This would eliminate the need to re-enter all data manually. As a backup option, a manual entry system can be made available for manual data entry. This also includes the ability to add or edit existing SPS data. Once the data is imported, each product will have to be manually located on the map based on a coordinate or grid system.

Once the product(s) has (have) been located, a map can be printed on any compatible printer. A further option is the ability to transfer the map and or description to a cell phone or PDA. The transfer protocol for the delivery of the data can be via TCP/IP. The data can be transmitted either via an infrared signal beaming or Bluetooth transmitter to a PDA or through the Internet via SMS or email message if the handheld device has the capability of receiving the data.

The SPS system can be programmed to accommodate multiple languages. In a multilingual version, the user has the option to select a desired language at any point during the search. The SPS will automatically switch to that language and remain in that language until switched again or a new search has begun. The SPS can display English as the default language at the start of searches. The main search page can be changed to a different language before beginning, at which point it will continue in that language until it is switched again or a new search is initiated.

The SPS is designed for interaction with customers and employees as well. There are different options for the kiosk. It can be as simple as a desktop computer with an LCD monitor or it could be as technologically advanced as a transparent liquid crystal display system with voice recognition software. The application that is built can be made compatible with all forms of displays and keyboard input functions. The size of the system is not limiting either, because the main application will be run from a server to accommodate for even running the application on a small notebook or tablet.

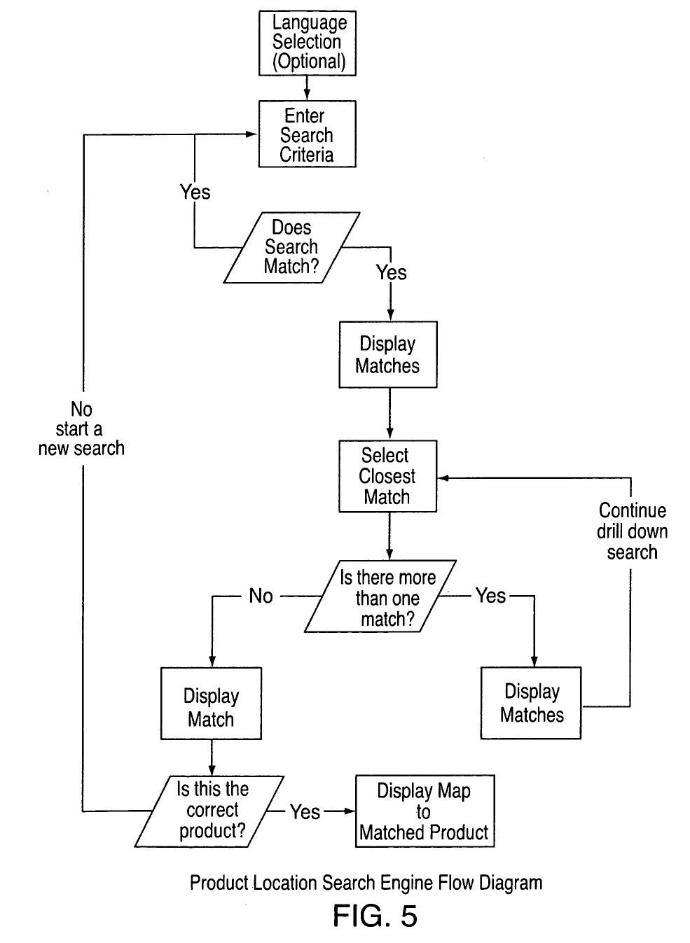

FIG. 5 is a flow diagram for a preferred implementation of a logic sequence for the User Interface of the SPS system. The main aspect is the searching function of the application. Products can be searched within the database. The system can be provided with intelligent search function that will be able to recall results from previous searches to enable the user to locate a product in a quicker time frame. Similar searches that have yielded similar results will provide the system with a more intelligent search for the product. Furthermore, the product can be searched in several different manners including by floor, by department, by brand, by type, by category, and by a general description, which will break down the sentence to basic keywords that yields matches. The keyword match will be weighted from left to right. The first words typed will carry a higher weight than those on the end. The first match will be that which matches all keywords in the same order of preference. Matched results will be displayed followed by matching categories, then matching type and brand if brand name matches are part of the search.

The user has the option to select any of the matches. If it is a direct match, then it will take the user directly to the product. However, if there are no direct matches, the user has the option to continue to drill-down the nearest match until a direct match occurs. Once a direct match occurs the user is taken directly to the product and it description, together with its current inventory which shows the availability of the product. If the product is in stock and available, the user has the option to locate the product.

If the user opts to locate the product, a map of the store or warehouse appears. The map uses a GIS (Geographical Information System) method of location. The product with an assigned locator ID correlates with a GIS plane coordinate system. The coordinate system pinpoints the location on the store map exactly the location of the product. A shortest path line will show the way to the product from the current location of the user. For larger stores and warehouses a simple form of Dykstra's Algorithm will be used for the best path to the product. This method uses the OSPF (Open Shortest Path First). However, for the simple and small stores, a common path method will be used which will be typical for most stores. For example, locating a product that is one floor above will show the path using the escalator since that is the more common path even if the elevator is closer and is the shortest path. The system also provides a physically challenged route for those in wheelchairs or walkers. This will show the route from the kiosk to the elevator. This will be provided only if an accessible route is available.

At this point, the user has the option to print a hard copy of the map to be taken and used to find the product. The printed map will show landmarks to identify the path for an easier time identifying the user's current location. The map will also show the product aisle number, and approximate shelf location and products it is in between if available. The map will be printed with the instructions in the language selected. The user also has the option to save paper and transfer the information to a mobile phone or PDA (Personal Digital Assistant) if it has the communications peripheral available on their PDA or mobile phone. The transfer of the data will be through the use of an SMS (short message service) or a mobile phone WAP (Wireless Application Protocol) via an email message with an attachment. The map will show up in a picture format as an attachment or directly as a picture. The picture will be in the format of a jpeg, tiff or bitmapped file.

Optionally, the Store Positioning System may be programmed for voice recognition input and audio response with a voice synthesized response. This can be used in conjunction with the physical (typed) search. This option is available with the inclusion of speakers and audio integration into the kiosk computer system. Other options include enabling the customer to electronically input a list of items shopped for from a flash memory device or from a cell phone, PDA, or other handheld device, or to upload a list of items shopped for to a store's website from a PC.

In summary, the Store Positioning System is a user friendly technology driven system that will enable to find products quickly and simply and entice customers to return to the store due to the friendliness and usability of the system for locating products. The system provides the customer with a printed or uploaded floor plan map with directions to the locations of the products requested marked on the map. In this manner, the customer can shop from department to department, or aisle to aisle, going to the exact locations of the products they requested, without having to backtrack or criss-cross around the store, thereby saving time and greatly adding to customer convenience.

It is understood that many modifications and variations may be devised given the above description of the principles of the invention. It is intended that all such modifications and variations be considered as within the spirit and scope of this invention, as defined in the following claims.

1. A store product locating system comprising:
(a) a product search input means adapted to enable a customer to input a name or phrase for a product they are searching for within the store and compose a search query for that product;
(b) a system database searchable by the search query provided by the product search input means to find a product name corresponding to the search query and its location within the store; and
(c) a product location map output means responsive to the search of the system database for the product name and its location found for outputting a map visually identifying the location of the product searched for by the customer.

2. A store product locating system according to claim 1, wherein the product search input means is a kiosk having a keyboard and search input display for inputting and visually confirming an input product name or phrase, and a display screen for displaying a floor plan map for the store displaying the found location for the product searched for.

3. A store product locating system according to claim 2, wherein the kiosk includes a printer for printing a map printout showing the found location for the product searched for the customer.

4. A store product locating system according to claim 2, wherein the kiosk includes an electronic receiver for enabling the customer to upload a list of product items searched for from a handheld device.

5. A store product locating system according to claim 4, wherein the electronic receiver includes an electronic transmitter for transmitting a map of product locations to the customer's handheld device.

6. A store product locating system according to claim 2, wherein the customer can input a number of products being searched for, and the system provides a map display of the location of each input product in turn along with already-input product locations maintained on the display screen.

7. A store product locating system according to claim 2, wherein the kiosk enables a customer to select one of a plurality of languages for display of a product and instructions to its location on the display screen.

8. A store product locating system according to claim 1, wherein the product search input means is adapted to enable a customer to upload a list of product items searched for to a store website on the Internet from a personal computer, and to obtain an output map either at the customer's personal computer or to be retrieved by the customer in the store.

9. A store product locating system according to claim 2, wherein the product location map output means outputs a map that includes directions from a present location of the customer at the kiosk to the product searched for.

10. A store product locating system according to claim 1, wherein the product location map output means outputs a map that displays the locations of a plurality of products searched for by the customer so that the customer can shop for the plurality of items conveniently.

11. A method of locating a product within a store comprising:
(a) providing a product search input means to enable a customer to input a name or phrase for a product they are searching for within the store and compose a search query for that product;
(b) searching a system database by the search query provided by the product search input means to find a product name corresponding to the search query and its location within the store; and
(c) providing a product location map in response to the search of the system database visually identifying the location of the product searched for by the customer.

12. A store product locating method according to claim 11, wherein the product search input means is a kiosk having a keyboard and search input display for inputting and visually confirming an input product name or phrase, and a display screen for displaying a floor plan map for the store displaying the found location for the product searched for.

13. A store product locating method according to claim 12, wherein the kiosk includes a printer for printing a map printout showing the found location for the product searched for the customer.

14. A store product locating method according to claim 12, wherein the kiosk includes an electronic receiver for enabling the customer to upload a list of product items searched for from a handheld device.

15. A store product locating method according to claim 14, wherein the electronic receiver includes an electronic transmitter for transmitting a map of product locations to the customer's handheld device.

16. A store product locating method according to claim 12, wherein the customer can input a number of products being searched for, and the system provides a map display of the location of each input product in turn along with already-input product locations maintained on the display screen.

17. A store product locating method according to claim 12, wherein the kiosk enables a customer to select one of a plurality of languages for display of a product and instructions to its location on the display screen.

18. A store product locating method according to claim 11, wherein the product search input means is adapted to enable a customer to upload a list of product items searched for to a store website on the Internet from a personal computer, and to obtain an output map either at the customer's personal computer or to be retrieved by the customer in the store.

19. A store product locating method according to claim 12, wherein the product location map output means outputs a map that includes directions from a present location of the customer at the kiosk to the product searched for.

20. A store product locating method according to claim 1, wherein the product location map output means outputs a map that displays the locations of a plurality of products searched for by the customer so that the customer can shop for the plurality of items conveniently.
